(19) United States
(12) Patent Application Publication
(10) Pub. No.: US 2007/0223933 A1
(43) Pub. Date: Sep. 27, 2007

(54) Optical transmitter with feed-forward compensation

(75) Inventors: Hoon Kim, Suwon-si (KR); Seong-Taek Hwang, Pyeongtaek-si (KR); Yeong-Wan Choi, Seoul (KR); Yeong-Seol Yun, Uiwang-si (KR); Jun-Jae Lee, Seoul (KR)

Correspondence Address: CHA & REITER, LLC, 210 ROUTE 4 EAST STE 103, PARAMUS, NJ, 07652, US

(73) Assignee: Samsung Electronics Co.; LTD

(21) Appl. No.: 11/653,151

(22) Filed: Jan. 12, 2007

(30) Foreign Application Priority Data
Mar. 21, 2006 (KR) 2006-25868

(51) Int. Cl. H04B 10/00

(52) U.S. Cl. 398/158

(57) ABSTRACT

An optical transmitter with a feed-forward compensation is disclosed. The optical transmitter includes a first light source receiving a second electrical signal to convert into a first optical signal, an optical splitter dividing the first optical signal into a second optical signal and a third optical signal, an optical detector converting the third optical signal into a fourth electrical signal, a comparator receiving the fourth electrical signal and a third electrical signal, to produce a fifth electrical signal corresponding to a difference between the third electrical signal and the fourth electrical signal, a second light source converting the fifth electrical signal into a fourth optical signal, and an optical combiner for offsetting a distortion component of the fourth optical signal against the second optical signal to produce a fifth optical signal.

### CLAIM OF PRIORITY

This application claims the benefit of the earlier filing date, under 35 U.S.C. § 119(a), to that patent application entitled “An Optical Transmitter With Feed-Forward Compensation,” filed in the Korean Intellectual Property Office on Mar. 21, 2006 and assigned Serial No. 2006-25868, the entire contents of which are hereby incorporated by reference.

### BACKGROUND OF THE INVENTION

1. Field of the Invention

The present invention relates generally to an optical transmitter, and more particularly, to an optical transmitter adapted to compensate in a feed-forward system for distortion of an optical signal induced in an electrical-to-optical conversion of an input electrical signal.

2. Description of the Related Art

A typical optical communications system generally consists of at least one base station and a plurality of subscriber terminal apparatus, in which the base station is arranged to provide subscribers with a variety of communication-related services and the subscriber terminal apparatus is connectable to the base station via optical fiber to be served the communication services as the subscribers demand. The base station is provided with a light source for producing a set of optical signals so that an input electrical signal is converted to an optical signal by means of known electrical-to-optical conversion. During such an electrical-to-optical conversion, some distortion is typically introduced into the original electrical signal. Therefore, there have been ever increasing demands for an optical transmitter designed to compensate for any undesirable component of distortion in the optical signal during an electrical-to-optical conversion of an electrical signal.

### SUMMARY OF THE INVENTION

The present invention provides an optical transmitter capable of compensating for distortion components in an optical signal resulting from an electrical-to-optical conversion of an input electrical signal in a wide range of frequency band for use in an optical communication system.

In accordance with one aspect of the present invention, there is provided an optical transmitter with a feed-forward compensation, including a first light source receiving a second electrical signal to convert into a first optical signal, an optical distributor dividing the first optical signal into a second optical signal and a third optical signal, an optical detector converting the third optical signal into a fourth electrical signal, a comparator receiving the fourth electrical signal and a third electrical signal having the same waveform as the second electrical signal to thereby produce a fifth electrical signal corresponding to a difference between the third electrical signal and the fourth electrical signal, a second light source converting the fifth electrical signal into a fourth optical signal, and an optical combiner for offsetting a distortion component of the fourth optical signal against the second optical signal to thereby produce a fifth optical signal.

### BRIEF DESCRIPTION OF THE DRAWINGS

The above features and advantages of the present invention will become more apparent from the following detailed description when taken in conjunction with the accompanying drawings in which:

FIG. 1 shows a schematic block diagram of an optical transmitter using a feed-forward compensation according to an embodiment of the present invention;

FIG. 2 shows a schematic block diagram of a phase shifter according to one example of the present invention; and

FIG. 3 shows a schematic block diagram of a phase shifter according to another example of the present invention.

### DETAILED DESCRIPTION

Exemplary embodiments of the present invention will now be described in detail with reference to the annexed drawings. In the drawings, the same or similar elements are denoted by the same reference numerals even though they are depicted in different drawings. For the purposes of clarity and simplicity, a detailed description of known functions and configurations incorporated herein has been omitted.

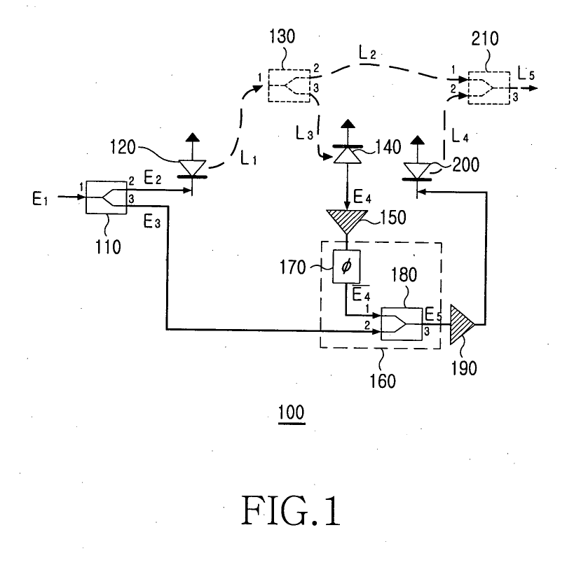

Referring now to FIG. 1, a description will be made to an optical transmitter 100 using a feed-forward compensation according to a preferred embodiment of the present invention. As shown, the optical transmitter 100 includes a first power distributor 110, a first light source 120, a second light source 200, an optical distributor 130, an optical detector 140, a comparator 160 having a phase shifter section 170 and a first power combiner 180, an optical coupler 210, and first and second amplifiers 150 and 190. In the embodiment of FIG. 1, the dotted lines represent a path for transmission of optical signals, while the solid lines represent a path for transmission of electrical signals.

The first power distributor 110 may have three input/output ports, in which a first port serves as an input terminal, and second and third ports each serve as an output terminal. The first power distributor 110 operates to split a first electrical signal E₁ received at the first port into a second electrical signal E₂ and a third electrical signal E₃ by means of power dividing, wherein the second electrical signal E₂ has the same waveform and phase as the third electrical signal E₃. The second electrical signal E₂ is output from the second port and the third electrical signal E₃ is output from the third port. Each of these first and second electrical signals has an electrical power level corresponding to one half of the electrical power in the first electrical signal E₁ (i.e., a 3 dB signal loss). Advantageously, the first electrical signal E₁ may be an RF signal, and a conventional RF distributor may be used as the first power distributor 110, so that it can process a wide frequency band of electrical signals ranging from 800 MHz to 2.1 GHz, for example. However, it would be recognized by those skilled in the art, that the frequency range may be extended below or above the values described herein without altering the scope of the invention.

The first light source 120 serves to convert the second electrical signal input from the first power distributor 110 into a first optical signal L₁. The first optical signal L₁ may have an original signal component produced by the electrical-to-optical conversion without any distortion from the second electrical signal E₂, and some distortion components resulted from the electrical-to-optical conversion. The first and second light sources 120 and 200 may include at least one light emitting diode or laser diode, or its equivalents.

The optical distributor 130 may have three input/output ports, in which a first port serves as an input terminal, and second and third ports each serve as an output terminal. The optical distributor 130 operates to power-split the first optical signal L₁ input from the first light source 120 through the first port into a second optical signal L₂ and a third optical signal L₃ by means of a power dividing, wherein the second optical signal L₂ has the same waveform and phase as the third Optical signal L₃. The second optical signal L₂ is output from the second port of the optical distributor 130 and the third optical signal L₃ is output from the third port. Each of these second and third optical signals has an electrical power level corresponding to one half of the electrical power in the first optical signal L₁. Advantageously, a conventional Y-branch waveguide may be used as the optical distributor 130. In this case there is no phase difference between the end-outputs in using such a Y-branch waveguide.

The optical detector 140 then operates to convert third optical signal L₃ input from the optical distributor 130 into a fourth electrical signal E₄. The optical detector 140 may be made from one or more photodiodes, which are well known in the art and need not be discussed in detail herein.

In the meantime, the first amplifier 150 serves to amplify the fourth electrical signal E₄ input from the optical detector 140, so that the first amplifier 150 provides for an increase in the electrical power level to allow an inverted signal E̅₄̅ of the fourth electrical signal to offset the third electrical signal E₃ when the inverted signal E̅₄̅ and E₃ are input to a first power combiner. The first and second amplifies 150 and 190 may be configured from one or more known RF amplifiers, which are well-known in the art and need not be discussed in detail herein.

The comparator 160 receives, at its one input port, the third electrical signal E₃ from the first power distributor 110 and, at its other input port, a fourth electrical signal E₄ from the first amplifier 150. The output of comparator 160 is a fifth electrical signal E₅ corresponding to a difference between the third electrical signal E₃ and the amplified fourth electrical signal E₄. Here, the fifth electrical signal E₅ will only consist of a distortion component of the original signal, with its phase inverted. That is, the phase of the fifth electrical signal E₅ is phase shifted by 180 or phase-inverted°. In the embodiment, the comparator 160 may have a phase shifter 170 for inverting the phase of the amplified, fourth electrical signal E₄, and a first power combiner 180 for combining the phase-inverted fourth electrical signal E̅₄̅ with the third electrical signal E₃. For effecting broader band of phase inversion, according to the embodiment, the phase shifter 170 may include a plurality of two or more, phase shifters, for example. Since a phase shifter generally has a limitation in operable frequency band in use, it would be particularly advantageous to use two or more phase shifters for processing wider frequency band of signals covering at least 800 MHz to 2.1 GHz that may be required in accordance with one aspect of the present invention. However, it would be recognized that the lower and upper frequencies shown herein may be extended without altering the scope of the invention.

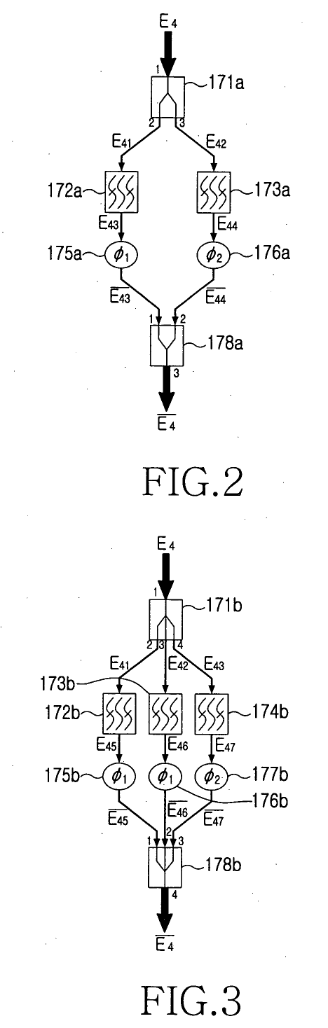

Referring to FIG. 2, description is made to a schematic block diagram for construction of a phase shifter section 170 according to a first embodiment of the present invention. The phase shifter includes a second power distributor 171a, first and second band-pass filters 172a and 172b, first and second phase shifters 175a and 176a, and a second power combiner 178a. In this embodiment, the first electrical signal E₄ includes a first frequency component E₄₃ and a second frequency component E₄₄, wherein the first frequency component E₄₃ may have a center frequency of 800 MHz and the second frequency component E₄₄ a center frequency of 2.1 GHz, for example.

The second power distributor 171a may have three input/output ports, wherein a first port serves as an input terminal, and second and third ports each serve as an output terminal. The second power distributor 171a operates to split the fourth electrical signal E₄ received at the first port into a first branch signal E₄₁ and a second branch signal E₄₂ by means of power dividing, wherein the first branch signal E₄₁ has the same waveform and phase as the second branch signal E₄₂. The first branch signal E₄₁ is output at the second port and the second branch signal E₄₂ is output at the third port. Each of these first and second branch signals has an electrical power level corresponding to one half of the electrical power in the fourth electrical signal E₄. Advantageously, a conventional RF distributor may be used for the second power distributor 171a.

The first band-pass filter 172a filters out the first branch signal E₄₁ input from the second power distributor 171a to provide the first frequency component E₄₃ at its output terminal, so that only the first frequency component is passed therethrough and other frequency components of input electrical signal are blocked. Likewise, the second band-pass filter 173a filters out the second branch signal E₄₂ input from the second power distributor 171a to provide the second frequency component E₄₄ at its output terminal, so that only the second frequency component E₄₄ is passed therethrough, and the other frequency components of input electrical signal are blocked.

The first phase shifter 175a performs a phase inversion of the first frequency component E₄₃ input from the first band-pass filter 172a, while the second phase shifter 176a similarly performs a phase inversion to the second frequency component E₄₄ input from the second band-pass filter 173a.

The second power combiner 178a may have three input/output ports, wherein first and second ports each serve as an input terminal, and a third port serves as an output terminal. The second power combiner 178a operates to combine an inverted first frequency component E̅₄̅₃̅ input from the first phase shifter 175a with an inverted second frequency component E̅₄̅₄̅ input from the second phase shifter 176a, to thereby output a phase-inverted fourth electrical signal E̅₄̅, as shown in FIG. 2.

Referring now to FIG. 3, description is made to the arrangement of a phase shifter section according to a second embodiment of the present invention. The phase shifter section includes the second power distributor 171b, first to third band-pass filters 172b, 173b and 174b, first to third phase shifters 175b, 176b and 177b, and a second power combiner 178b. In this embodiment, the first electrical signal E₁ includes a first frequency component E₄₅, a second frequency component E₄₆, and a third frequency component E₄₇, wherein, for example, the first frequency component E₄₅ may have a center frequency of 800 MHz, the second frequency component E₄₆ a center frequency of 1.8 GHz, and the third frequency component E₄₇ a center frequency of 2.1 GHz

The second power distributor 171b may have four input/output ports, wherein a first port serves as an input terminal, and second to fourth ports each serve as an output terminal. The second power distributor 171b operates to divide the fourth electrical signal E₄ received at the first port into a first branch signal E₄₁, a second branch signal E₄₂, and a third branch signal E₄₃ by means of power dividing in equal parts by 3, wherein the first branch signal E₄₁ has the same waveform and phase as the second and third branch signals E₄₂ and E₄₃. The first branch signal E₄₁ is output at the second port and the second and third branch signals E₄₂ and E₄₃ are respectively output at the third and fourth ports. Each of these first to third branch signals E₄₁ to E₄₃ has an electrical power level corresponding to one third of the electrical power in the amplified input fourth electrical signal E₄. Advantageously, a conventional RF distributor may be used for the second power distributor 171b.

The first band-pass filter 172b filters out the first branch signal E₄₁ input from the second power distributor 171b to supply only the first frequency component E₄₅ at its output terminal, so that only the first frequency component E45 is passed therethrough, and the other frequency components of input signal are blocked. Likewise, the second band-pass filter 173b filters out the second branch signal E₄₂ input from the second power distributor 171b to supply only the second frequency component E₄₆ at its output terminal, so that only the second frequency component E₄₆ is passed therethrough, and the other frequency components of the input signal are blocked. Similarly, the third band-pass filter 174b filters out the third branch signal E₄₇ input from the second power distributor 171b to supply only the third frequency component E₄₇ at its output terminal, so that only the third frequency component E₄₇ is passed therethrough, and the other frequency components of the input signal are blocked.

In the meantime, the first phase shifter 175b makes a phase inversion to the first frequency component E₄₅, input from the first band-pass filter 172b, and the second phase shifter 176b similarly makes a phase inversion to the second frequency component E₄₆, input from the second band-pass filter 173b. Further, the third phase shifter 177b also performs a phase inversion on the third frequency component E₄₇ input from the second band-pass filter 174b.

The second power combiner 178b may have four input/output ports, wherein its first to third ports each serve as an input terminal, while a fourth port serves as an output terminal. The second power combiner 178b operates to combine an inverted first frequency component E̅₄̅₅̅ input from the first phase shifter 175b, an inverted second frequency component E̅₄̅₆̅ input from the second phase shifter 176b and an inverted third frequency component E̅₄̅₇̅ input from the second phase shifter 177b, to produce a phase-inverted fourth electrical signal E̅₄̅ at its output, as shown in FIG. 3.

Referring back to FIG. 1, the first power combiner 180 may have three input/output ports, in which its first and second ports serve as an input terminal, and the third port serves as an output terminal. The first power combiner 180 operates to combine the third electrical signal E₃ input from the first power distributor 110 with the phase-inverted fourth electrical signal E̅₄̅ input from the phase shifter 170, thereby producing a fifth electrical signal E5 at its output. Using this power combining stage, the original component of the phase-inverted fourth electrical signal E̅₄̅ is offset against the third electrical signal E₃, so that the fifth electrical signal E₅ only consists of a phase-inverted distortion component.

The second amplifier 190 amplifies the fifth electrical signal E₅ delivered from the first power combiner 180. Here, the second amplifier 190 amplifies the fifth electrical signal E₅ so that the electrical power level is increased to allow the fourth electrical signal E₄ to be offset against the distortion components of the second optical signal L₂ at the time of inputting to the optical combiner 210. The second light source 200 performs a conversion of the amplified fifth electrical signal E₅ input from the second amplifier 190 into a fifth optical signal L₄ by means of electrical-to-optical conversion. The fourth optical signal L₄ will include only the distortion components.

In the meantime, the optical combiner 210 may have three input/output ports, in which its first and second ports serve as an input terminal, and the third port serves as an output terminal. The optical combiner 210 operates to combine the second optical signal L₂ input from the first optical distributor 130 with the fourth optical signal E₄ input from the second optical source 200, thereby producing a fifth optical signal E₅ at its output. In this power combining stage, distortion components of the second optical signal L₂ is efficiently offset against the fourth optical signal L₄, so that the fifth optical signal L₅ may consist of the original signal components only.

Although embodiments of the present invention have been disclosed for illustrative purposes, those skilled in the art will appreciate that various modifications, additions and substitutions are possible, without departing from the scope and spirit of the invention as disclosed in the accompanying claims.

For example, at least one conventional inverting amplifier may be used for the phase shifter 170. This inverting amplifier may have one input terminal and one output terminal, in which the input terminal is connectable to the output terminal of the optical detector 140 and the output terminal is connectable to the first port of the first power combiner 180. The inverting amplifier performs an amplification of the fourth electrical signal E₄ input from the optical detector 140 as well as a phase inversion thereto, and then delivers the amplified, phase-inverted fourth electrical signal E̅₄̅ to the first power combiner 180. This inverting amplifier operates to make an amplification of the fourth electrical signal E₄ input from the optical detector 140, so that it allows an original component of the amplified phase-inverted fourth electrical signal E̅₄̅ to offset against the third electrical signal E3 at the time of inputting to the first power combiner 180. The first and second amplifies 150 and 190 may be configured from one or more known RF amplifiers. Advantageously, in case such an inverting amplifier is used for the phase shifter 170, the first amplifier 150 may be omitted from the arrangement as descried heretofore. More advantageously, a field effect transistor (FET) with a common source or a bipolar junction transistor (BJT) with a common emitter may be used for the inverting amplifier.

As is appreciated from the above description, the optical transmitter with a feed-forward compensation according to the present invention has an advantage in that it can compensate for distortion components of an original optical signal, offsetting the distortion components of the optical signal induced by an electric-to-optical conversion against its phase-inverted distortion components.

Additionally, the optical transmitter with a feed-forward compensation according to the present invention has further advantage in that it could compensate for the distortion components induced from the electric-to-optical conversion in a wide range of frequency band, as a phase shift section for generating a phase-inverted distortion component is provided with a plurality of phase shifters. Accordingly, it would be appreciated that the optical transmitter with a feed-forward compensation according to the present invention has an advantage in that it can be adapted to simultaneously operate two or more mobile communications services using different frequency bands from each other.

While the invention has been shown and described with reference to a certain preferred embodiment thereof, it will be understood by those skilled in the art that various changes in form and details may be made therein without departing from the spirit and scope of the invention as defined by the appended claims.

What is claimed is:

1. An optical transmitter with a feed-forward compensation, comprising:
a first light source receiving a second electrical signal to convert into a first optical signal;
an optical splitter power dividing the first optical signal into a second optical signal and a third optical signal;
an optical detector converting the third optical signal into a fourth electrical signal;
a comparator receiving the fourth electrical signal and a third electrical signal, the third signal having the same waveform as the second electrical signal, to thereby produce a fifth electrical signal corresponding to a difference between the third electrical signal and the fourth electrical signal;
a second light source converting the fifth electrical signal into a fourth optical signal; and
an optical combiner for combining the fourth optical signal and the second optical signal to thereby produce a fifth optical signal, said fifth optical signal offsetting the distortion component.

2. The optical transmitter with a feed-forward compensation according to claim 1, further comprising:
a first power distributor for dividing in electrical power an input first electrical signal into the second and third electrical signals.

3. The optical transmitter with a feed-forward compensation according to claim 2, wherein said comparator comprises:
a phase-shifting section for inverting the phase of the fourth electrical signal, and
a first power combiner for offsetting the original signal component of the phase-inverted fourth electrical signal against the third electrical signal.

4. The optical transmitter with a feed-forward compensation according to claim 3, wherein said phase shifting section comprises:
a second power distributor for splitting the fourth electrical signal into a plurality of branch signals;
a plurality of band-pass filters each connected to receive the branch signals for filtering the respective branch signals to thereby output a specified frequency component corresponding to the respective branch signal;
a plurality of phase shifters each connected to the band-pass filter for phase-inverting the corresponding frequency component input from the respective band-pass filter; and
a second power combiner for combining the inverted frequency components from the plurality of phase shifters with each other, to thereby generate a phase-inverted fourth electrical signal.

5. The optical transmitter with a feed-forward compensation according to claim 1, further comprising:
a first amplifier for amplifying the fourth electrical signal received from the optical detector to provide the amplified electrical signal to the comparator.

6. The optical transmitter with a feed-forward compensation according to claim 5, further comprising:
a second amplifier for amplifying the fifth electrical signal received from the comparator to provide the amplified electrical signal to the second light source.

7. The optical transmitter with a feed-forward compensation according to claim 2, wherein said comparator comprises:
an inverting amplifier for performing an amplification and phase-inversion of the fourth electrical signal; and
a first power combiner for offsetting an original signal component of the amplified phase-inverted fourth electrical signal against the third electrical signal for erasing of the original signal component.

8. A method for compensating distortion in electrical-optical conversion comprising the steps of:
performing a conversion of an electrical signal into an optical signal;
determining a level of distortion occurring during the conversion of the electrical signal into the optical signal, wherein the determined level of distortion is represented as a distortion signal; and
removing the determined level of distortion from the optical signal.

9. The method according to claim 8, wherein the step of determining the level of distortion comprises the steps:
converting the optical signal to a second electrical signal; and
comparing the electrical signal to the second electrical signal.

10. The method of claim 9, wherein the step of comparing comprises the steps of:
inverting the second electrical signal; and
subtracting the second electrical signal from the electrical signal.

11. The method of claim 8, wherein in the step of removing the level of distortion comprises the steps of:
converting the distortion signal to a distortion optical signal; and
subtracting the distortion optical signal from the optical signal.

12. An optical apparatus with a feed-forward compensation, comprising:
means for power dividing an input first electrical signal into a second electrical signal and a third electrical signal, the third signal has the same waveform as the second electrical signal;
means for converting the second electrical signal into a first optical signal;
means for dividing the first optical signal into a second optical signal and a third optical signal;
means for converting the third optical signal into a fourth electrical signal;
means for producing a fifth electrical signal corresponding to a difference between the third electrical signal and the fourth electrical signal, said fifth electrical signal representing a distortion signal;
means for converting the fifth electrical signal into a fourth optical signal; and
means for combining the fourth optical signal and the second optical signal to produce a fifth optical signal, said fifth optical signal offsetting the distortion component.

13. The optical apparatus according to claim 12, wherein said means for determining the distortion signal comprises:
a phase-shifting section for inverting the phase of the fourth electrical signal, and
a first power combiner for offsetting the original signal component of the phase-inverted fourth electrical signal against the third electrical signal.

14. The optical apparatus according to claim 13, wherein said phase shifting section comprises:
a second power distributor for splitting the fourth electrical signal into a plurality of branch signals;
a plurality of band-pass filters each connected to receive the branch signals for filtering the respective branch signals to thereby output a specified frequency component corresponding to the respective branch signal;
a plurality of phase shifters each connected to the band-pass filter for phase-inverting the corresponding frequency component input from the respective band-pass filter; and
a second power combiner for combining the inverted frequency components from the plurality of phase shifters with each other, to thereby generate a phase-inverted fourth electrical signal.

15. The optical apparatus according to claim 12, further comprising:
means for amplifying the fourth electrical signal.

16. The optical apparatus according to claim 15, further comprising:
means for amplifying the fifth electrical signal.

17. The optical apparatus according to claim 12, wherein said means for producing a fifth electrical signal comprises:
an inverting amplifier for performing an amplification and phase-inversion of the fourth electrical signal; and
a first power combiner for offsetting an original signal component of the amplified phase-inverted fourth electrical signal against the third electrical signal for erasing of the original signal component.

18. The optical apparatus according to clam 17, wherein the inverting amplifier is an FET.
